(19) United States
(12) Patent Application Publication
(10) Pub. No.: US 2026/0104743 A1
(43) Pub. Date: Apr. 16, 2026

(54) ELECTRONIC DEVICE INCLUDING FLEXIBLE DISPLAY

(71) Applicant: Samsung Electronics Co., Ltd., Suwon-si (KR)

(72) Inventors: Van Tu TRUONG, Bac Ninh Province (VN); Trong Toan LE, Bac Ninh Province (VN); Hong Ly NGUYEN, Bac Ninh Province (VN); Huu Tung NGUYEN, Bac Ninh Province (VN); Quang Huy NGUYEN, Bac Ninh Province (VN); Van Do NGUYEN, Bac Ninh Province (VN); Thi Phuong Nhung PHAM, Bac Ninh Province (VN)

(21) Appl. No.: 19/289,574

(22) Filed: Aug. 4, 2025

Related U.S. Application Data
(63) Continuation of application No. PCT/KR2025/010484, filed on Jul. 16, 2025.

(30) Foreign Application Priority Data
Oct. 10, 2024 (KR) 10-2024-0137872

(51) Int. Cl. G06F 1/16

(52) U.S. Cl. CPC G06F 1/1681; G06F 1/1652

(57) ABSTRACT

An electronic device is provided. The electronic device includes a housing of which one surface is open, a roller, a flexible display that contacts the roller and is configured to roll, a first support plate that is coupled with the flexible display within the housing, a deployment device for adjusting a rolling state of the flexible display by pushing or pulling the first support plate within the housing, and a second support plate that is coupled with the deployment device on the opposite side of the first support plate based on the deployment device, wherein the deployment device supports a rear surface of the flexible display while the flexible display is unfolded.

### CROSS-REFERENCE TO RELATED APPLICATION(S)

This application is a continuation application, claiming priority under 35 U.S.C. § 365(c), of an International application No. PCT/KR2025/010484, filed on Jul. 16, 2025, which is based on and claims the benefit of a Korean patent application number 10-2024-0137872, filed on Oct. 10, 2024, in the Korean Intellectual Property Office, the disclosure of which is incorporated by reference herein in its entirety.

### TECHNICAL FIELD

The disclosure relates to an electronic device including a rollable flexible display.

### BACKGROUND ART

As display technologies have developed, research and development for an electronic device including a flexible display are actively going on.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

Accordingly, electronic devices are being transformed to various shapes, breaking away from uniform shapes. For example, a flexible display in a form that can be wound or unfolded (i.e., a rollable display) can be applied to an electronic device and used. However, in a conventional electronic device including a rollable display, the flexible display is not supported properly from the inside when the flexible display is unfolded, and thus there is a problem that the flexible display may be damaged.

### Solution to Problem

Aspects of the disclosure are to address at least the above-mentioned problems and/or disadvantages and to provide at least the advantages described below. Accordingly, an aspect of the disclosure is to provide an electronic device including a rollable flexible display.

Additional aspects will be set forth in part in the description which follows and, in part, will be apparent from the description, or may be learned by practice of the presented embodiments.

In accordance with an aspect of the disclosure, an electronic device is provided. The electronic device includes a housing of which one surface is open, a roller, a flexible display that contacts the roller and is configured to roll, a first support plate that is coupled with the flexible display within the housing, a deployment device for adjusting a rolling state of the flexible display by pushing or pulling the first support plate within the housing, and a second support plate that is coupled with the deployment device on the opposite side of the first support plate based on the deployment device, wherein the deployment device supports a rear surface of the flexible display while the flexible display is unfolded.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating an electronic device according to an embodiment of the disclosure;

FIG. 2 is an exploded perspective view of an electronic device according to an embodiment of the disclosure;

FIG. 3 is a diagram wherein a flexible display has been removed from FIG. 1 according to an embodiment of the disclosure;

FIG. 4 is a diagram for illustrating a state wherein a first support plate and a second support plate have been removed from FIG. 3 according to an embodiment of the disclosure;

FIGS. 5 and 6 are diagrams for illustrating a base element to which a guide element is coupled according to various embodiments of the disclosure;

FIGS. 7 and 8 are diagrams for illustrating a guide element according to various embodiments of the disclosure;

FIG. 9 is a diagram for illustrating a support element according to an embodiment of the disclosure;

FIGS. 10A, 10B, and 10C are diagrams for illustrating a configuration and components of the support element in FIG. 9 according to various embodiments of the disclosure;

FIG. 11 is a diagram for illustrating connecting elements according to an embodiment of the disclosure;

FIG. 12A is a diagram for illustrating a state wherein a side surface part of a support bar is assembled to a base element according to an embodiment of the disclosure;

FIG. 12B is a diagram for illustrating a state wherein a side surface part of a support bar is assembled to a guide element according to an embodiment of the disclosure;

FIG. 13 is a diagram for illustrating an operation that a support bar changes each rail along a guide element according to an embodiment of the disclosure;

FIGS. 14A, 14B, and 14C are diagrams for illustrating an operation of a deployment device according to various embodiments of the disclosure;

FIG. 15 is a block diagram of an electronic device according to an embodiment of the disclosure; and

FIG. 16 is a diagram for illustrating an electronic device further including a second housing that is extended according to an embodiment of the disclosure.

The same reference numerals are used to represent the same elements throughout the drawings.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Meanwhile, with respect to the detailed description of the drawings, similar or related components may be designated by similar reference numerals.

Also, a singular form of a noun corresponding to an item may include one of the item or a plurality of the items, unless instructed obviously differently in the related context.

In addition, in the disclosure, each of the phrases “A or B,” “at least one of A and B,” “at least one of A or B,” “A, B, or C,” “at least one of A, B, and C,” and “at least one of A, B, or C” may include any one of the items listed together with the corresponding phrase among the phrases, or all possible combinations thereof.

Further, the term “and/or” includes a combination of a plurality of related components described, or any one component among the plurality of related components described.

Also, terms such as “first,” “second,” and the like may be used just to distinguish a component from another component, and are not intended to limit a component in another aspect (e.g.: importance or order).

Meanwhile, in case it is mentioned that a component (e.g.: a first component) is “coupled” or “connected” with another component (e.g.: a second component) together with terms such as “functionally” and “communicatively” or without such terms, it means that the component may be connected with the another component directly (e.g.: in a wired manner), wirelessly, or through a third component.

Also, terms such as “include” or “have” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in case it is mentioned that one element is “connected with,” “combined with,” “supported by,” or “contacted with” another element not only includes a case wherein the elements are directly connected, combined, supported, or contacted, but also a case wherein the elements are indirectly connected, combined, supported, or contacted through a third element.

Further, the description in the disclosure that one element is “on top of” another element not only includes a case wherein the one element contacts the another element, but also a case wherein still another element exists between the two elements.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Hereinafter, an electronic device 1 according to various embodiments will be described in detail with reference to the drawings.

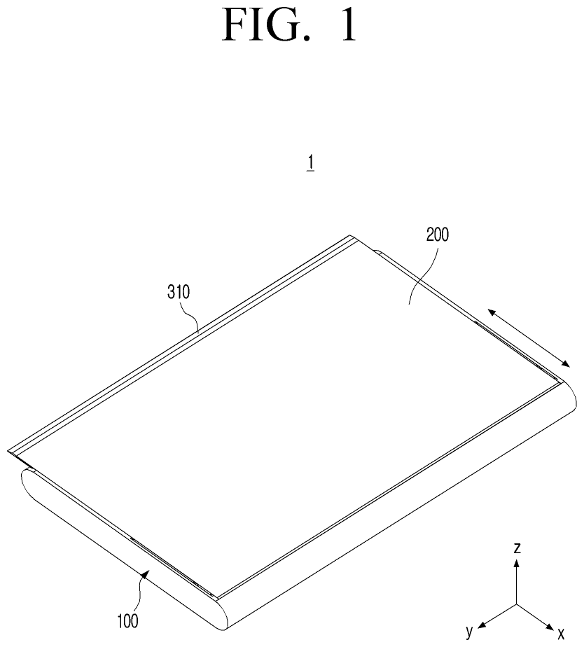

FIG. 1 is a perspective view illustrating an electronic device according to an embodiment of the disclosure.

Referring to FIG. 1, an electronic device 1 is a device including a flexible display. The flexible display may be bent by various methods. According to a form or a method of being bent, various terms may be used such as bending, folding, rolling, and the like. Among them, rolling means a form wherein the flexible display can be rolled like a roll or unfolded. The flexible display in the various embodiments of the disclosure can be rolled or unfolded by using a roller, and thus it may be referred to as a rollable display.

The electronic device 1 may provide screens in various sizes by using a flexible display.

According to FIG. 1, the electronic device 1 includes a housing 100, a flexible display 200, and a support plate. The support plate is a component for being connected with the flexible display 200 and transmitting an external force. The support plate may be divided into a plurality of support plates according to the locations. In FIG. 1, a first support plate 310 which is one of them is illustrated.

Specifically, on the upper part of the housing 100 of the electronic device 1, the first support plate 310 and the flexible display 200 may be seated. The lower surface on one side of the flexible display 200 may be coupled with the upper surface of the first support plate 310.

The first support plate 310 may be supported in a slidable form by the side surface of the housing 100. In this case, if the first support plate 310 slides, the flexible display 200 coupled to the first support plate 310 may also move together. For example, in FIG. 1, if the first support plate 310 is pushed or pulled in the direction of the −x axis on the upper side of the housing 100, the flexible display 200 may also be unfolded or rolled up in the direction of the −x axis together with the first support plate 310.

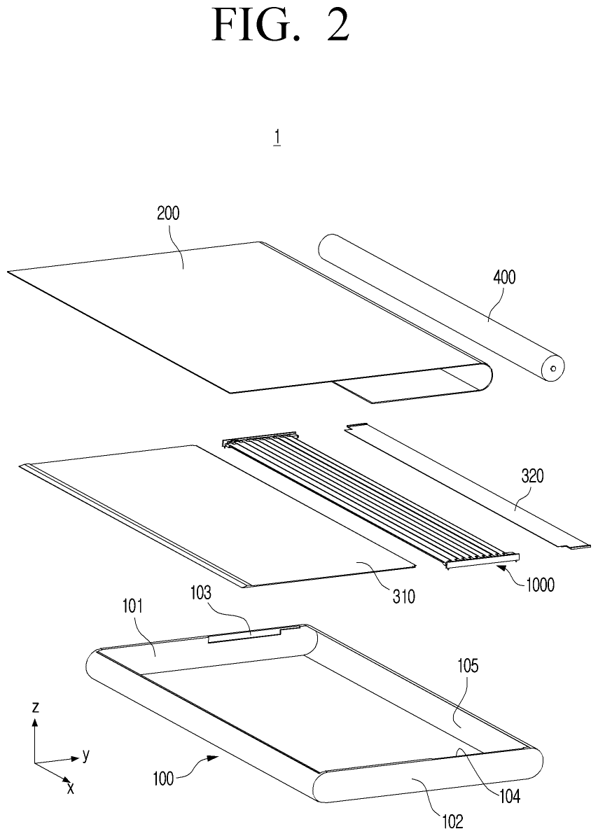

As detailed explanation regarding each component of the electronic device 1 including a rollable device in FIG. 1 will be described from FIG. 2, explanation in this regard will be omitted.

FIG. 2 is an exploded perspective view of the electronic device 1 according to an embodiment of the disclosure.

Referring to FIG. 2, the electronic device 1 may include a housing 100, a flexible display 200, a first support plate 310, a second support plate 320, a roller 400, and a deployment device 1000.

Referring to FIG. 2, the housing 100 is a component for housing parts and components necessary for the electronic device 1. The housing 100 may alternatively be replaced by various terms such as a body, a case, a cover, and the like. Also, the housing 100 may be in a form of which one surface is open as shown in FIG. 2. Various components are mounted in the direction of the open surface, and the flexible display 200 is mounted on the outermost side (i.e., the uppermost surface in FIG. 2).

Also, the upper side parts of both side surfaces 101, 102 of the housing 100 may include coupling parts 103, 104. To the coupling parts 103, 104 of the housing 100, the deployment device 1000 may be coupled. The coupling parts 103, 104 may be in forms of grooves to which the deployment device 1000 can be coupled.

The front surface part 105 of the housing 100 may have a bent form. In FIGS. 1 and 2, it is illustrated that both of the front surface part 105 and the rear surface part facing the front surface part 105 are in a bent form, but the disclosure is not limited thereto.

On the front surface part 105 in a bent form, the roller 400 that will be described later may be seated. In FIG. 2, the roller 400 is illustrated on the outer side of the flexible display 200, but this is for easily illustrating the structure of the roller 400, and in an actual product, the roller 400 may be arranged to adhere to the inner surface of the flexible display 200. Accordingly, the flexible display 200 gets to rotate together by a rotation of the roller 400. According to the rotation direction of the roller 400, the flexible display 200 gets to be unfolded or wound.

Referring to FIG. 2, it was illustrated that one roller 400 is arranged only on the front surface part, but the disclosure is not necessarily limited thereto, and the roller 400 may include a plurality of rollers that are seated in various locations such as the rear surface part, the side surface part, and the like, of the housing 100.

Also, in FIG. 2, the first support plate 310, the second support plate 320, and the deployment device 1000 may be arranged on the one open surface of the housing 100. Specifically, the first support plate 310 may be arranged on the upper surface of the housing 100, and the deployment device 1000 may be coupled to the side part on the +x axis of the first support plate 310. Also, to the side part of the +x axis of the deployment device 1000, the second support plate 320 may be coupled. On the upper side of the first support plate 310, the deployment device 1000, and the second support plate 320, the flexible display 200 may be arranged. The upper side surface of the first support plate 310 and the lower surface of a part of the flexible display 200 may be in a coupled state. Accordingly, as the deployment device 1000 is driven, the first support plate 310 may be pushed or pulled, and along with this, the flexible display 200 may also be unfolded or wound.

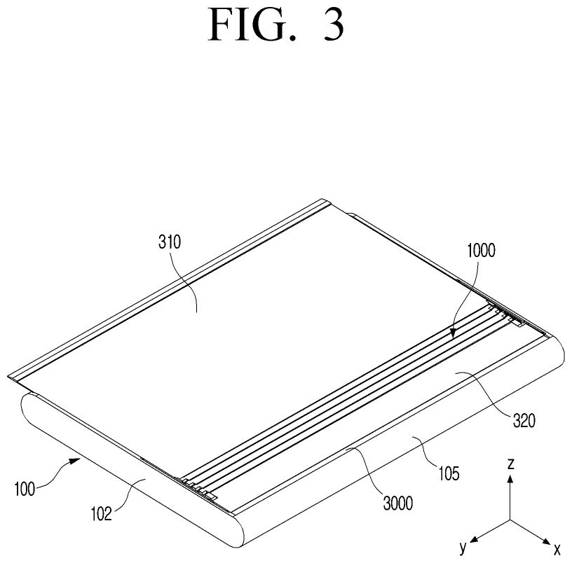

Between the second support plate 320 and the front surface part 105 of the housing 100, a slit (the reference numeral 3000 in FIG. 3) may be formed. Accordingly, the flexible display 200 wound around the roller 400 may pass between the slit (the reference numeral 3000 in FIG. 3) and may be drawn to the outside of the housing 100, or enter the inside of the housing 100.

Referring to FIG. 2, the flexible display 200 is a display that can be bent as a flexible material is used. The first support plate 310, the second support plate 320, and the deployment device 1000 may support the flexible display 200 on the upper side. The flexible display 200 may perform various operations such as displaying various kinds of screens, or receiving an input of a touch manipulation of the user, and the like, in an unfolded state. A part of the flexible display 200 may be in a form of being wound around the roller 400 inside the housing 100. By a rotation of the roller 400, the flexible display 200 may be unfolded or wound.

Referring to FIG. 2, the roller 400 may be arranged inside the housing 100, and the roller 400 may have a cylindrical shape. The roller 400 may include a through hole in the central part of the side surface. Accordingly, although not illustrated in the housing 100 in FIG. 2, a fixing pin element may be included in the side surface part of the front surface part 105 of the housing 100, and the roller 400 may be coupled to it. Accordingly, the roller 400 may be coupled to the inside of the housing 100 and rotate, and may thereby unfold or wind the flexible display 200.

Referring to FIG. 2, the deployment device 1000 is a component for adjusting the rolling state of the flexible display 200 by pushing or pulling the first support plate 310 within the housing 100. The deployment device 1000 may support the rear surface of the flexible display 200 while the flexible display 200 is unfolded. The deployment device 1000 may alternatively be described as various terms such as a support device, a compensation device, and the like.

As the detailed components and configuration of the deployment device 1000 will be described later, explanation in this regard will be omitted.

FIG. 3 is a diagram illustrating a state wherein a flexible display has been removed from FIG. 1 according to an embodiment of the disclosure.

Referring to FIG. 3, the first support plate 310 may be arranged on the upper surface of the housing 100, and a part of the first support plate 310 may be in a form of protruding from the housing 100. For example, in FIG. 3, a part of the first support plate 310 is arranged on the upper surface of the housing 100, and the rest of the first support plate 310 protrudes in the −x axis direction of the housing 100. However, the disclosure is not limited thereto, and the entire lower surface of the first support plate 310 may be arranged on the upper surface of the housing 100, or a part of the lower surface of the first support plate 310 may have a form of protruding in the +y axis direction or the −y axis direction.

Referring to FIG. 3, the deployment device 1000 may be coupled with the side surface of the +x axis part of the first support plate 310. Through this, the deployment device 1000 may be driven, and push the first support plate 310 in the −x axis direction, or pull the first support plate 310 in the +x axis direction.

Also, in FIG. 3, the second support plate 320 may be coupled with the side surface of the +x axis part of the deployment device 1000 in the upper part of the housing 100. In addition, the second support plate 320 may be arranged in a form of being spaced from the front surface part 105 in the upper part of the housing 100 by a specific distance. Such a part spaced by a specific distance may be referred to as a slit 3000. The slit 3000 is a space wherein the flexible display 200 can enter the inside of the housing 100, or can be drawn to the outside of the housing 100.

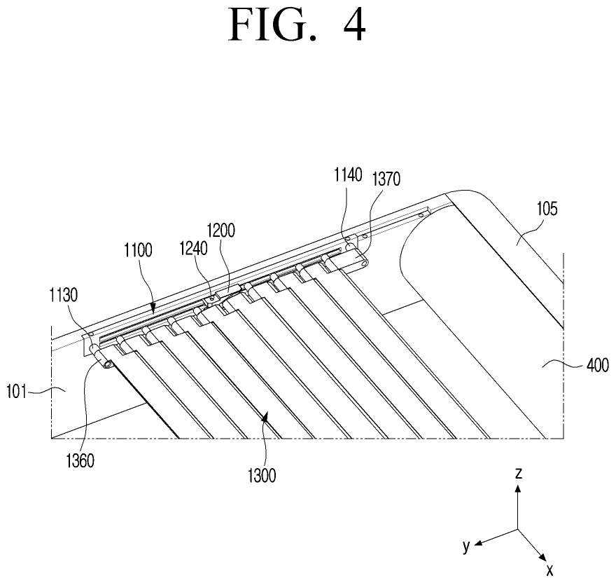

FIG. 4 is a diagram for illustrating a state wherein a first support plate and a second support plate have been removed from FIG. 3 according to an embodiment of the disclosure.

Referring to FIG. 4, the deployment device 1000 may include a base element 1100, a guide element 1200, and a support element 1300.

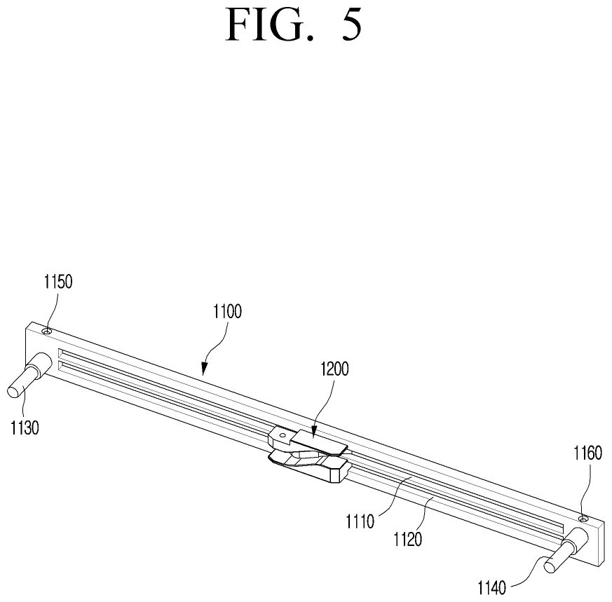

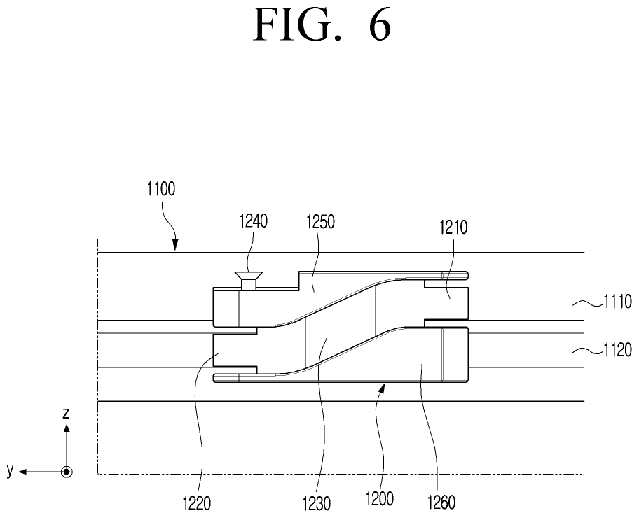

Also, in FIG. 4, the base element 1100 is an element that includes a plurality of rails of different heights that can slide the first support plate 310 in the deployment device 1000. The base element 1100 may be coupled to the upper part of the side surface part 101 of the housing 100. In FIG. 4, a base element 1100 coupled to one side surface of the housing 100 was illustrated, but a base element 1100 may be symmetrically coupled to the opposite side surface of the housing 100. The base element 1100 may include a plurality of rails of different heights. On both side surfaces of the base element 1100, fixing pin elements 1130 and 1140 may be arranged. Accordingly, the base element 1100 may be coupled with both side parts 1360 and 1370 of the support element 1300 through the fixing pin elements 1130 and 1140. The second fixing pin element 1140 may be coupled to the assembly element 1370 for coupling with the base element 1100 in the support element 1300. As detailed explanation regarding the structure of the base element 1100 will be described in FIGS. 5 and 6, explanation in this regard will be omitted.

Further, in FIG. 4, the guide element 1200 is an element that is assembled to the plurality of rails having different heights that are arranged on the inner side surface of the base element 1100, and is movable along the longitudinal direction of the plurality of rails. The guide element 1200 may include a guide body that slides along the base element 1100, and a sliding part 1230 that is tapered to connect a first rail 1110 and a second rail 1120 within the guide body. The guide element 1200 may include a screw element 1240 on one side of the upper side surface. The screw element 1240 is for coupling the guide element 1200 and the first support plate 310, and the guide element 1200 may be coupled with the first support plate 310 located in the +y axis direction through the screw element 1240. Through this, when the guide element 1200 moves along the longitudinal direction of the plurality of rails, the first support plate 310 may also move following the guide element 1200. Accordingly, the flexible display 200 coupled to the upper surface of the first support plate 310 may also move following the guide element 1200. As detailed explanation regarding the configuration and the components of the guide element 1200 will be described later, explanation in this regard will be omitted.

Also, in FIG. 4, the support element 1300 is an element that can move to one of the plurality of rails according to the location of the guide element 1200. Through this, the support element 1300 may support the rear surface of the flexible display 200 in the part that moved to the upper rail among the plurality of rails. On the contrary, the part of the support element 1300 that moved to the lower rail among the plurality of rails may be spaced from the rear surface of the flexible display 200. Specifically, the part of the support element 1300 that moved to the lower rail among the plurality of rails may be arranged lower than the guide element 1200, and may be arranged in the lower part of the first support plate 310. As detailed explanation regarding the configuration and the components of the support element 1300 will be described later, explanation in this regard will be omitted.

In addition, in FIG. 4, the roller 400 may be arranged to be spaced from the inner side surface of the front surface part 105 of the housing 100 by a specific distance. Through this, even if the entire flexible display 200 enters the inside of the housing 100, the roller 400 wherein the entire flexible display 200 is rolled up may be arranged on the inner side surface of the front surface part 105 of the housing 100, and may rotate flexibly. Also, the specific distance can prevent damage due to contact of the flexible display 200 with the housing 100.

FIGS. 5 and 6 are diagrams for illustrating a base element to which a guide element is coupled according to various embodiments of the disclosure. Specifically, FIG. 5 is a perspective view of the base element 1100 to which the guide element 1200 is coupled, and FIG. 6 is a front view of the base element 1100 to which the guide element 1200 is coupled.

Referring to FIG. 5, the base element 1100 may include a plurality of rails 1110 and 1120 of different heights, a plurality of fixing pin elements 1130 and 1140, and a plurality of through holes 1150 and 1160.

Also, in FIG. 5, the plurality of rails 1110 and 1120 of different heights may include a first rail 1110 corresponding to the upper rail on the inner side surface of the base element 1100, and a second rail 1120 corresponding to the lower rail on the inner side surface of the base element 1100. Specifically, the plurality of rails 1110 and 1120 may include a first rail 1110 formed in a location close to the flexible display 200 on the inner side surface of the base element 1100, and a second rail 1120 formed in a location farther than the first rail 1110 based on the location of the flexible display 200. However, the plurality of rails are not necessarily limited to the first rail 1110 and the second rail 1120, and they may be formed as a plurality of rails of different heights that are three or more according to the structure of the electronic device 1.

In addition, in FIG. 5, the plurality of fixing pin elements 1130 and 1140 may be coupled to the holes on both sides of the support element 1300. The plurality of fixing pin elements 1130 and 1140 may be formed in both side parts on the inner side surface of the base element 1100. Specifically, the plurality of fixing pin elements 1130 and 1140 may include a first fixing pin element 1130 located on the end in the +y axis direction in the base element 1100, and a second fixing pin element 1140 located on the end in the −y axis direction in the base element 1100. In FIG. 5, the first fixing pin element 1130 may be formed in a location of the same height as the second rail 1120 in the base element 1100. The second fixing pin element 1140 may be formed in a location of the same height as the first rail 1110 in the base element 1100. Accordingly, when the support element 1300 is coupled with the base element 1100, even if the guide element 1200 moves in the longitudinal direction of the plurality of rails, the support element 1300 may move to the first rail 1110 or the second rail 1120 without being damaged.

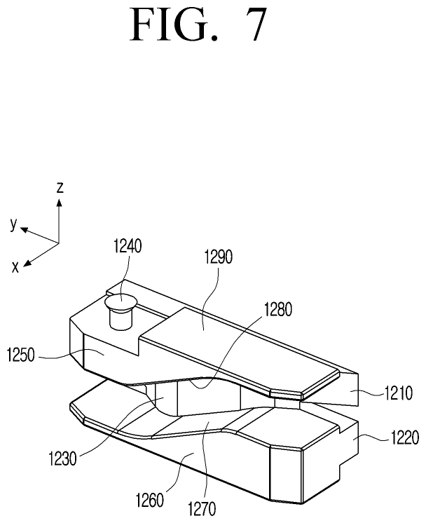

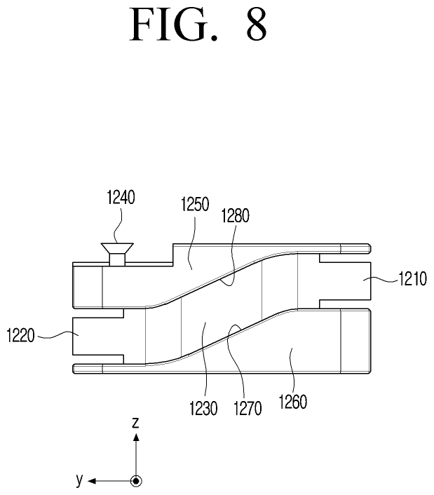

Referring to FIG. 6, the rear surface of the guide element 1200 may be assembled to the plurality of rails 1110 and 1120 of the base element 1100. As the detailed components and configuration of the guide element 1200 will be described later in FIGS. 7 and 8, explanation in this regard will be omitted.

Also, in FIG. 6, the guide element 1200 may slide along the plurality of rails 1110 and 1120 of different heights. On one side of the upper part of the guide element 1200, a screw element 1240 may be arranged. To such a screw element 1240, the first support plate 310 may be coupled. However, the first support plate 310 is not necessarily limited to be coupled with the guide element 1200 by the screw element 1240, and the first support plate 310 and the guide element 1200 may be coupled by various methods. Accordingly, as the guide element 1200 slides along the longitudinal direction of the plurality of rails 1110 and 1120, the first support plate 310 and the flexible display 200 coupled with the first support plate 310 may slide in an integrated state.

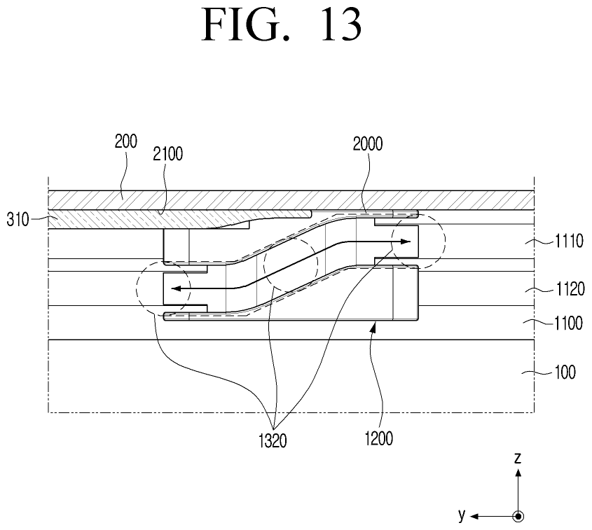

Referring to FIGS. 5 and 6, in the electronic device 1, if the guide element 1200 moves in a first direction, the flexible display 200 may be unfolded by the first support plate 310, and the support element 1300 may move to the first rail 1110 and support the rear surface of the flexible display 200. Also, in the electronic device 1, if the guide element 1200 moves in a second direction opposite to the first direction, the flexible display 200 may be rolled up by the first support plate 310, and the support element 1300 may move to the second rail 1120 and may be spaced from the rear surface of the flexible display 200. As detailed explanation regarding such an operation will be described in FIG. 13, explanation in this regard will be omitted.

FIGS. 7 and 8 are diagrams for illustrating a guide element according to various embodiments of the disclosure. Specifically, FIG. 7 is a perspective view of the guide element 1200, and FIG. 8 is a front view of the guide element 1200.

Referring to FIGS. 7 and 8, the guide element 1200 may include a first rail assembly part 1210, a second rail assembly part 1220, a sliding part 1230, a first support part 1250, and a second support part 1260.

Also, in FIGS. 7 and 8, the first rail assembly part 1210 and the second rail assembly part 1220 may be arranged in forms of straight lines protruding from the rear surface of the guide element 1200, and may be of sizes corresponding to the widths of the first rail 1110 and the second rail 1120 of the base element 1100. However, the disclosure is not necessarily limited thereto, and the first rail assembly part 1210 and the second rail assembly part 1220 may be formed in various shapes for not being separated from the first rail 1110 and the second rail 1120 of the base element 1100. Also, the first rail assembly part 1210 and the second rail assembly part 1220 may be in a form of being spaced from each other by a specific distance.

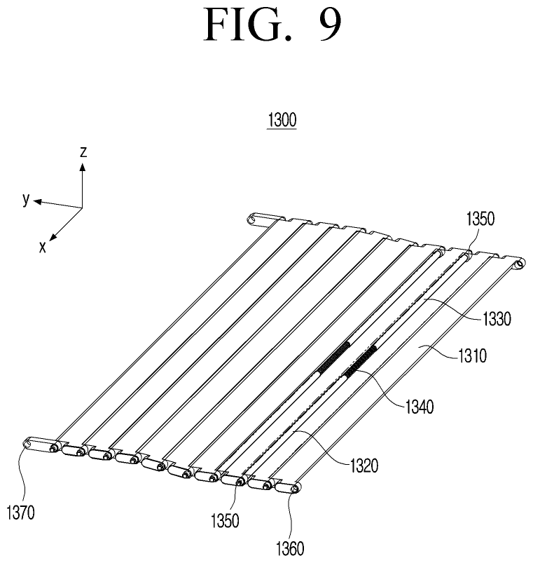

In addition, in FIGS. 7 and 8, the sliding part 1230 may be in a tapered form so as to connect the first rail 1110 and the second rail 1120 of the base element 1100 within the body of the guide element 1200. Specifically, the central part of the sliding part 1230 may be formed in a shape that protrudes to the +x axis, and is tilted in the −x axis direction as it is closer to the both side parts. The central part of the sliding part 1230 falls under a switching rail that is tapered such that a plurality of support bars (the reference numeral 1310 in FIG. 9) are switched between the first rail 1110 and the second rail 1120. Through this, if a force is not provided to a spring element (the reference numeral 1340 in FIG. 9) of the support element 1300, the support element 1300 cannot move between the first rail 1110 and the second rail 1120 of the base element 1100. Accordingly, in case the flexible display 200 is fixed, the electronic device 1 can prevent unfolding or roll-up of the flexible display 200 without the user's intent.

The sliding part 1230 may be coupled with the rear surface part of the first rail assembly part 1210 and the second rail assembly part 1220. The sliding part 1230 may include a form that is tilted from the rear surface part of the first rail assembly part 1210 toward the central part of the sliding part 1230. Likewise, the sliding part 1230 may include a form that is tilted from the rear surface part of the second rail assembly part 1220 toward the central part of the sliding part 1230. Accordingly, the sliding part 1230 may be a tapered structure wherein the rear surface part of the first rail assembly 1210, the central part of the guide element 1200, and the rear surface part of the second rail assembly 1220 are connected. Accordingly, the support element 1300 may move from the first rail 1110 to the second rail 1120, or move from the second rail 1120 to the first rail 1110 as the guide element 1200 slides. Also, the sliding part 1230 may include the protruding lower surface of the first support part 1250 and the protruding upper surface of the second support part 1260.

Accordingly, when the support element 1300 changes the rail between the plurality of rails 1110 and 1120 in the guide element 1200, detachment from the sliding part 1230 can be prevented.

The sliding part 1230 may have a diagonal form for moving between the first rail 1110 and the second rail 1120. However, the disclosure is not necessarily limited thereto, and the sliding part 1230 may have various structures that can move between the first rail 1110 and the second rail 1120.

Referring to FIGS. 7 and 8, the first surface 1290 in the upper part of the first support part 1250 may have a flat form, and the second surface (not shown) in the upper part of the first support part 1250 may have a flat form in a location spaced from the first surface 1290 by a specific distance. The upper part of the first support part 1250 may include the screw element 1240. As detailed explanation in this regard was described in the aforementioned part, explanation in this regard will be omitted. The lower part of the first support part 1250 is in a form of protruding to the +x axis direction, and may have a diagonal form for moving from the first rail 1110 to the second rail 1120. The diagonal form is a form of starting from the −y axis and the −z axis, and continuing to the +y axis and the +z axis, as the reference numeral 1230 in FIG. 8.

Also, in FIGS. 7 and 8, the lower part of the second support part 1260 may have a flat form. The upper part of the second support part 1260 is in a form of protruding to the +x axis direction, and may have a diagonal form for moving from the first rail 1110 to the second rail 1120. Meanwhile, both side parts in diagonal forms in the lower part of the first support part 1250 and the upper part of the second support part 1260 may have forms of straight lines parallel to the y axis.

In addition, in FIGS. 7 and 8, the height of the first surface 1290 arranged in the upper part of the first support part 1250 may be the same as the height of the upper surface of the first support plate 310. Also, in case the support element 1300 is located on the first rail 1110, the height of the upper surface of the support element 1300 may also be the same as the height of the upper surface of the first support plate 310 and the height of the first surface 1290 in the upper part of the first support part 1250. Accordingly, the lower surface of the flexible display 200 can be supported by the flat elements.

Through this, while the plurality of support bars 1310 are performing an operation of switching the first rail 1110 or the second rail 1120, the first support part 1250 and the second support part 1260 can prevent detachment of the switching rail.

FIG. 9 is a diagram for illustrating a support element according to an embodiment of the disclosure.

Referring to FIG. 9, a support element 1300 may include a plurality of support bars 1310, and connecting elements 1320, 1330 and 1340. The connecting elements 1320, 1330 and 1340 may connect between the plurality of support bars 1310, and may be fixed between them.

Also, in FIG. 9, the plurality of support bars 1310 may independently move to the first rail 1110 or the second rail 1120 of the base element 1100 according to the location of the guide element 1200. Accordingly, when the plurality of support bars 1310 are in the location of the first rail 1110, the plurality of support bars 1310 may support the flexible display 200. On the contrary, when the plurality of support bars 1310 are in the location of the second rail 1120, the plurality of support bars 1310 may be spaced from the rear surface of the flexible display 200.

In addition, in FIG. 9, the connecting elements 1320, 1330 and 1340 may include a first axis element 1320, a second axis element 1330, and an elastic body 1340. The first axis element 1320 and the second axis element 1330 may be arranged on both sides of the connecting elements 1320, 1330 and 1340. Specifically, the first axis element 1320 and the second axis element 1330 may respectively be assembled to the inner side surfaces of the guide element 1200 and the base element 1100.

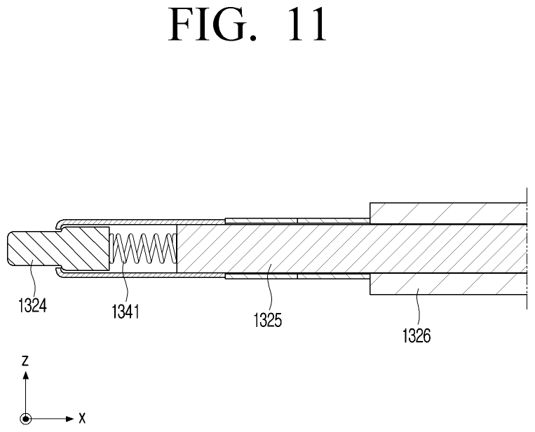

Further, in FIG. 9, the elastic body 1340 of the connecting elements 1320, 1330 and 1340 may be arranged between the first axis element 1320 and the second axis element 1330. That is, in FIG. 9, the elastic body 1340 may be arranged in the central part of the connecting elements 1320, 1330 and 1340. However, the disclosure is not limited thereto, and the elastic body 1340 may be arranged on any one point of the side surface part of the connecting elements 1320, 1330 and 1340 as in FIG. 11. Detailed explanation in this regard will be described in FIG. 11.

Also, in FIG. 9, the elastic body 1340 may be arranged between the first axis element 1320 and the second axis element 1330, and pass through the sliding part 1230 of the guide element 1200. Specifically, as the elastic body 1340 passes through the tapered sliding part 1230 of the guide element 1200, it may contract as a force is transmitted. Accordingly, the first axis element 1320 and the second axis element 1330 may be moved to the central part of the connecting elements 1320, 1330 and 1340. Accordingly, the support element 1300 may move between the first rail 1110 and the second rail 1120.

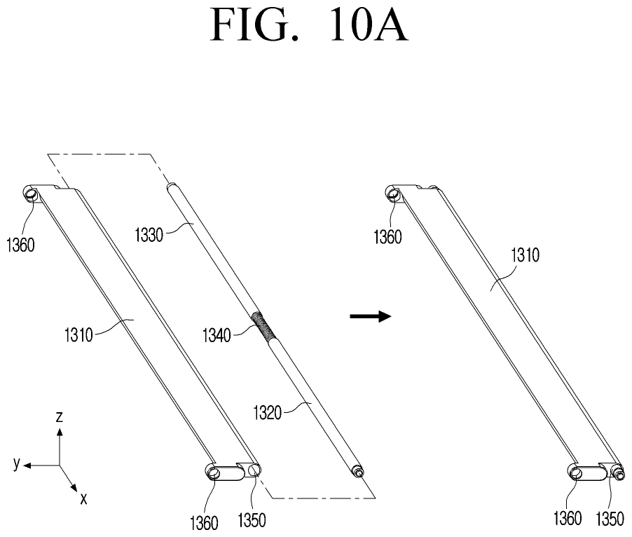

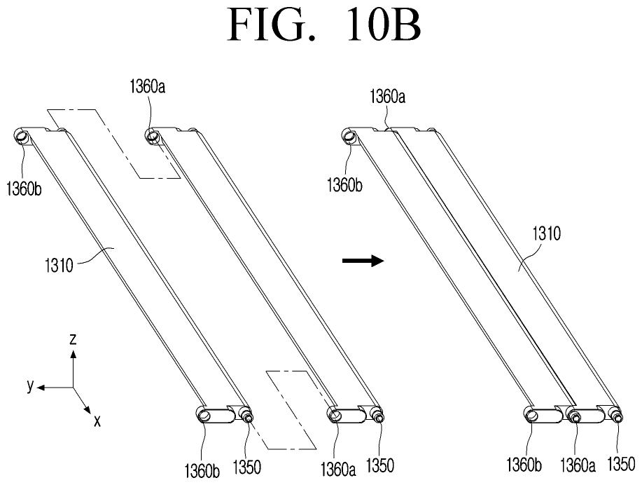

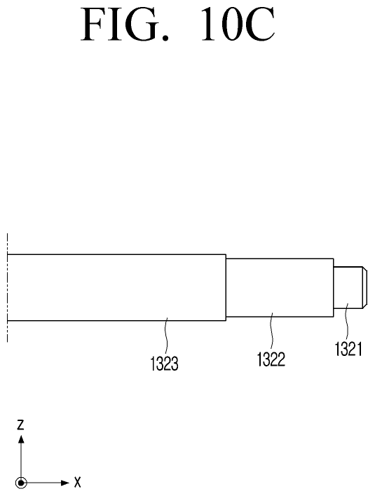

The relation of connection between the plurality of support bars 1310 and the connecting elements 1320, 1330 and 1340 of the support element 1300 in FIG. 9 will be explained in detail through FIGS. 10A to 10C.

The reference numeral of the plurality of support bars 1310 was expressed as 1310, but hereinafter, a single support bar will also be explained through the reference numeral 1310 for the convenience of explanation.

FIGS. 10A, 10B, and 10C are diagrams for illustrating a configuration and components of a support element in FIG. 9 according to various embodiments of the disclosure. Specifically, FIG. 10A is a diagram for illustrating the relation of coupling between a single support bar 1310 and the connecting elements 1320, 1330 and 1340, FIG. 10B is a diagram for illustrating the relation of coupling with the single support bar 1310 to which the connecting elements 1320, 1330 and 1340 in FIG. 10A are coupled, and FIG. 10C is a diagram for illustrating the side surface structures of the first axis element 1320 and the second axis element 1330 arranged in the side part of the connecting elements 1320, 1330 and 1340.

Referring to FIG. 10A, the single support bar 1310 may include a body and a bending element bent on both side surfaces of the body. The bending element may have a form of being bent in the lower direction on both side surfaces of the body. The bending element may include a first connecting hole 1350 and a second connecting hole 1360. Specifically, the bending element may further include an auxiliary element protruding to the outer side direction in the rear surface parts of both side surfaces. Accordingly, the front surface part of the bending element not protruding to the outer side direction may include the first connecting hole 1350, and the rear surface part of the auxiliary element protruding from the bending element may include the second connecting hole 1360.

Also, in FIG. 10A, in both side parts of the connecting elements 1320, 1330 and 1340, the first axis element 1320 and the second axis element 1330 may be arranged, and the elastic body 1340 may be arranged between the first axis element 1320 and the second axis element 1330. The elastic body 1340 may have a material that can have a restoring force. For example, the elastic body 1340 may consist of various materials such as a spring, rubber, silicon, latex, and polyurethane, and the like. Through this, in case a force is added to both side surfaces of the connecting elements 1320, 1330 and 1340, their length may be decreased as the elastic body 1340 contracts. Afterwards, in case the force on both side surfaces of the connecting elements 1320, 1330 and 1340 is removed, the connecting elements 1320, 1330 and 1340 may return to their original state by the restoring force of the elastic body 1340.

In addition, in FIG. 10A, the connecting elements 1320, 1330 and 1340 may be coupled to the first connecting hole 1350. Specifically, a force may be added to both side surfaces of the connecting elements 1320, 1330 and 1340, and their length may be decreased by contraction of the elastic body 1340. Afterwards, the connecting elements 1320, 1330 and 1340 may be coupled to the first connecting hole 1350. Afterwards, when the force on both side surfaces of the connecting elements 1320, 1330 and 1340 is removed, a state wherein the connecting elements 1320, 1330 and 1340 are connected to the single support bar 1310 may be formed.

Referring to FIG. 10B, the single support bar 1310 to which the connecting elements 1320, 1330 and 1340 are coupled may be coupled with another support bar 1310. Specifically, for the connecting elements 1320, 1330 and 1340 formed in the front surface part of the single support bar 1310 to which the connecting elements 1320, 1330 and 1340 are coupled, a force to a degree that the connecting elements may not be detached from the first connecting hole 1350 may be added to both side parts, and their length may thereby contract. Afterwards, after the connecting elements 1320, 1330 and 1340 are coupled to the second connecting hole 1360a arranged in the rear surface part of the another support bar 1310, the force on the connecting elements 1320, 1330 and 1340 may be removed. Afterwards, a plurality of coupled support bars 1310 may be formed by the restoring force of the elastic body 1340. For example, in the relation of coupling of these coupled support bars 1310, the components may be connected in the order of the connecting elements 1320, 1330 and 1340, the first connecting hole 1350 of the first support bar 1310, and the second connecting hole 1360a of the first support bar 1310 from the inner side to the outer side.

Also, in FIG. 10B, the second connecting hole 1360b arranged on the leftmost side among the support bars 1310 may be coupled with the first fixing pin element 1130 of the base element 1100 as can be seen in FIG. 4. The first connecting hole 1350 arranged on the rightmost side among the support bars 1310 may be coupled to the connecting elements 1320, 1330 and 1340, and then assembled to the rails 1110 and 1120 after an assembly element (the reference numeral 1370 in FIG. 4) is additionally assembled on the outer side. The assembly element 1370 may be coupled to the second fixing pin element 1140 and may be supported by the base element 1100, as can be seen in FIG. 4.

FIG. 10C is a diagram regarding the configurations of the first axis element 1320 and the second axis element 1330 of the connecting elements 1320, 1330 and 1340. In the explanation of the drawing, explanation will be described based on the first axis element 1320, but the second axis element 1330 will be formed in the same configuration.

Referring to FIG. 10C, the first axis element 1320 may include a first chamfer 1321, a second chamfer 1322, and a third chamfer 1323.

The first chamfer 1321 is an element that can be assembled to the first rail 1110 and/or the second rail 1120 of the base element 1100. The first chamfer 1321 may have a form wherein the side surface part on the outer side is flat. Also, in FIG. 10C, the cross-section of the first chamfer 1321 may have a circular shape, and the entire shape of the first chamfer 1321 may have a cylindrical shape. However, the disclosure is not necessarily limited thereto, and the first chamfer 1321 may have various forms that can slide on the first rail 1110 and the second rail 1120 of the base element 1100, and/or the guide element 1200.

The second chamfer 1322 may have a bigger diameter than the first chamfer 1321. Also, the second chamfer 1322 may be arranged on the inner side of the first chamfer 1321. Further, the second chamfer 1322 may be supported by the inner side surface of the base element 1100. Specifically, the first chamfer 1321 may be assembled to the first rail 1110 and/or the second rail 1120, and the part excluding the first chamfer 1321 of the outer side surface of the second chamfer 1322 may have a structure of contacting the inner side surface of the base element 1100. By the restoring force of the elastic body 1340 of the connecting elements 1320, 1330 and 1340, the part excluding the first chamfer 1321 of the outer side surface of the second chamfer 1322 may contact the inner side surface of the base element 1100, and may thereby slide stably on the base element 1100.

The third chamfer 1323 may have a bigger diameter than the second chamfer 1322. Also, the third chamfer 1323 may be arranged on the inner side of the second chamfer 1322. Further, the third chamfer 1323 may be fixed to the plurality of support bars 1310. Through this, the connecting elements 1320, 1330 and 1340 may be fixed while being coupled to the support bars 1310. Accordingly, the support element 1300 may unfold or roll up the flexible display 200 stably through the base element 1100 and the guide element 1200.

FIG. 11 is a diagram for illustrating a connecting elements according to an embodiment of the disclosure. FIG. 11 illustrates connecting elements having different configurations from the aforementioned connecting elements 1320, 1330 and 1340.

Referring to FIG. 11, the connecting elements 1320, 1330 and 1340 may include a first axis element 1324 and a second axis element (not shown) arranged on each outer side surface. Also, the connecting elements 1320, 1330 and 1340 may include a supporting body 1325 between the first axis element 1324 and the second axis element (not shown). The first axis element 1324 and the second axis element (not shown) may further include an elastic body 1341. Specifically, the elastic body 1341 may be arranged on the inner side of the first axis element 1324 and the second axis element (not shown), and may be arranged between the supporting body 1325. Accordingly, the connecting elements 1320, 1330 and 1340 may decrease in their length by the elastic body 1341 of the first axis element 1324 and the second axis element (not shown), or may be restored to their original length by the restoring force.

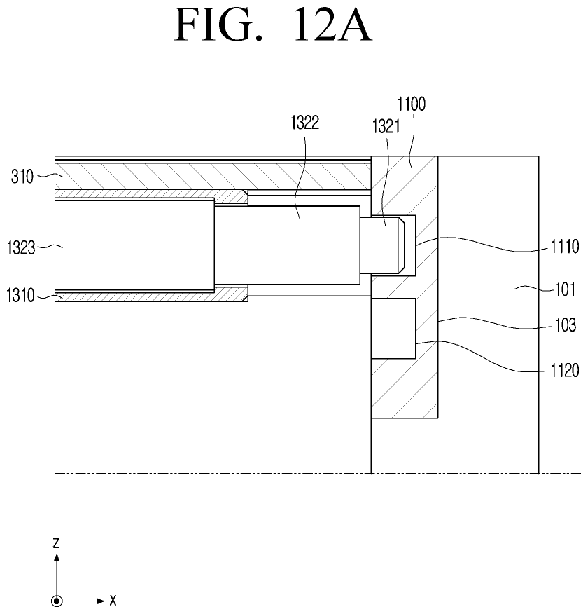

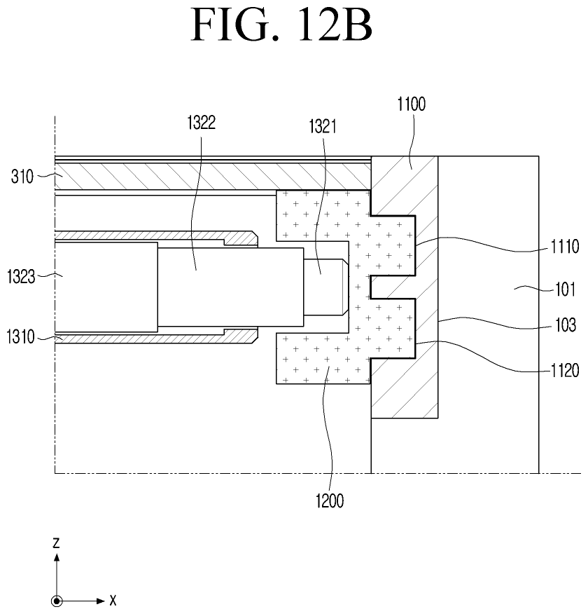

FIGS. 12A and 12B are diagrams for illustrating a state wherein a side surface part of a support bar is assembled to the base element according to various embodiments of the disclosure. Specifically, FIG. 12A is a diagram for illustrating a state wherein the side surface part of the support bar 1310 is supported by the first rail 1110 or the second rail 1120 of the base element 1100, and FIG. 12B is a diagram for illustrating a state wherein the side surface part of the support bar 1310 is supported by the guide element 1200.

Referring to FIG. 12A, on the outermost side surface of the electronic device 1, the first side surface 101 of the housing 100 may be arranged. On the upper surface of the first side surface 101, the coupling part 103 may be arranged, and on the coupling part 103, the base element 1100 may be seated. On the inner side surface of the base element 1100, the plurality of rails 1110 and 1120 may be arranged. On the inner side of the upper side part of the base element 1100, the first support plate 310 and the flexible display 200 may be arranged. The height of the flexible display 200 may be the same as the height of the upper side surface of the base element 1100.

In the lower part of the first support plate 310, the support element 1300 may be arranged. In the support element 1300, the upper surface of the support bar 1310 may contact the lower surface of the first support plate 310. Through this, the support bar 1310 may support the first support plate 310. On the inner side of the support bar 1310, the connecting elements 1320, 1330 and 1340 may be included. Specifically, the part excluding the second chamfer 1322 of both side surfaces of the third chamfer 1323 may support the first connecting hole 1350 of the support bar 1310 of the connecting elements 1320, 1330 and 1340. A part of the outer side surface of the second chamfer 1322 may contact the inner side surface of the first connecting hole 1350 of the support bar 1310. Also, the part excluding the first chamfer 1321 of both side surfaces of the second chamfer 1322 may contact the inner side surface of the base element 1100. However, the part does not necessarily contact the inner side surface of the base element 1100, and it may vary according to the length of the first chamfer 1321. The outer side surface of the first chamfer 1321 may contact the upper side surface and the lower side surface of the first rail 1110 or the second rail 1120 of the base element 1100. Through this, the support element 1300 may slide on the first rail 1110 or the second rail 1120, and may be supported stably.

Referring to FIG. 12B, explanation regarding the housing 100, the first support plate 310, the flexible display 200, the base element 1100, and the support element 1300 is identical to the explanation in FIG. 12A. FIG. 12B illustrates a configuration wherein the guide element 1200 is further included in the configuration in FIG. 12A. Specifically, FIG. 12B is a side view illustrating a state wherein the support bar 1310 of the support element 1300 is changing the rail between the first rail 1110 and the second rail 1120 of the base element 1100 through the guide element 1200.

The rear surface of the guide element 1200 may be connected with the first rail 1110 and the second rail 1120 of the base element 1100. The guide element 1200 may slide in the longitudinal direction of the rails.

FIG. 12B illustrates a state wherein the support bar 1310 of the support element 1300 is seated on the sliding part 1230 of the guide element 1200. As the sliding part 1230 of the guide element 1200 is tapered, the length of the connecting elements 1320, 1330 and 1340 of the support bar 1310 may contract by the elastic body 1340. Specifically, the support element 1300 may be formed in a state wherein the support bar 1310 of the support element 1300 is arranged as it is, and only the connecting elements 1320, 1330, 1340 contract to the inner side. That is, as the elastic body 1340 in the connecting elements 1320, 1330 and 1340 is decreased, the first axis element 1320 arranged on the right side may move in the −x axis direction, and the second axis element 1330 arranged on the left side may move in the +x axis direction. Accordingly, the support element 1300 may flexibly pass through the sliding part 1230 of the guide element 1200, and may thereby move between the first rail 1110 and the second rail 1120 of the base element 1100.

FIG. 13 is a diagram for illustrating an operation that a support bar changes each rail along the guide element according to an embodiment of the disclosure.

Referring to FIG. 13, explanation will be described based on the first axis element 1320 of the connecting elements 1320, 1330 and 1340, but explanation will be applied identically to the second axis element 1330 arranged on the opposite side.

On the upper side of the guide element 1200, the flexible display 200 may be arranged. Also, the first support plate 310 may be arranged in the +y axis direction on the upper side of the guide element 1200. The guide element 1200 may be coupled to the first rail 1110 or the second rail 1120, and slide in the longitudinal direction of the rail. Accordingly, the first support plate 310 coupled with the guide element 1200 may also slide integrally with the guide element 1200.

If the guide element 1200 slides in the left direction of the rail, a part of the support bar 1310 arranged on the left side of the guide element 1200 may move to the right side of the guide element 1200, and at the same time, move from the second rail 1120 to the first rail 1110. Specifically, a part of the support bar 1310 may be arranged on the second rail 1120, and then slide through the sliding part 1230 of the guide element 1200, and may thereby move from the second rail 1120 to the first rail 1110 arranged on the upper side of the base element 1100. Accordingly, the support bar 1320 may support the extended flexible display 200 together with the first support plate 310.

On the contrary, if the guide element 1200 slides in the right direction of the rail, a part of the support bar 1310 arranged on the right side of the guide element 1200 may move to the left side of the guide element 1200, and at the same time, move from the first rail 1110 to the second rail 1120. Specifically, after the connecting elements 1320, 1330 and 1340 of the support element 1300 that were arranged on the first rail 1110 pass through the sliding part 1230 of the guide element 1200, a part of the support bar 1310 may be moved and arranged on the second rail 1120. Accordingly, as the first support plate 310 slides to the right side, the flexible display 200 may also slide to the right side, and the support element 1300 may move to the lower part of the first support plate 310 in a process of supporting the flexible display 200.

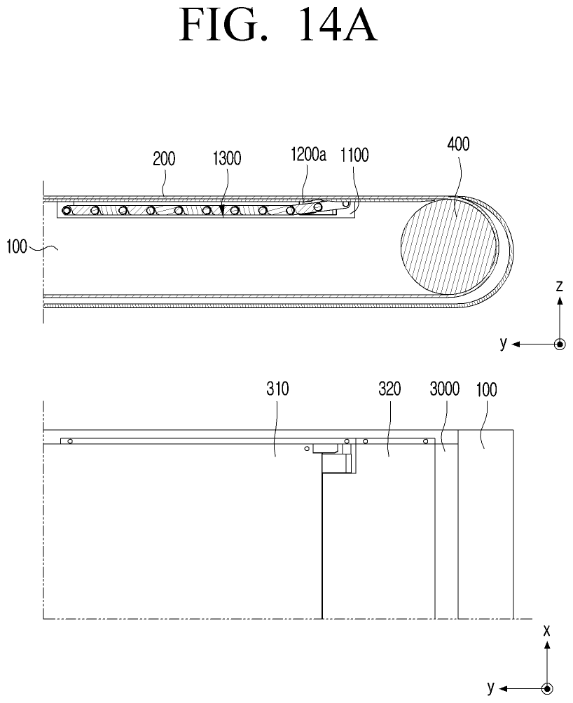

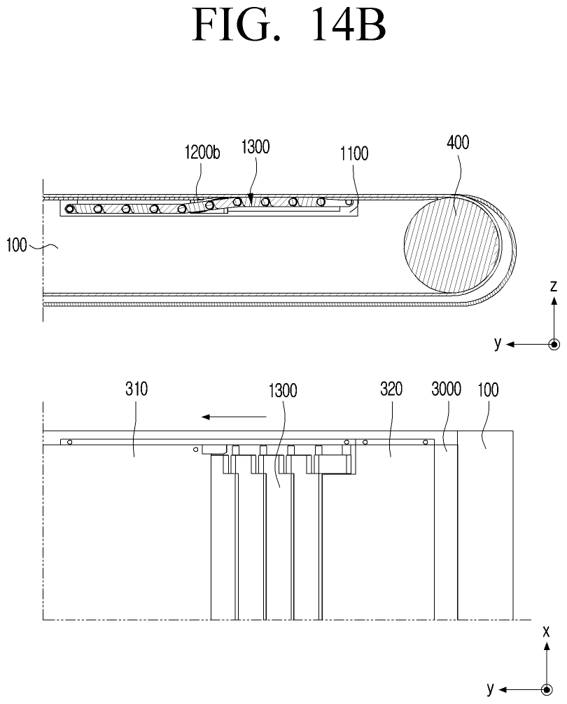

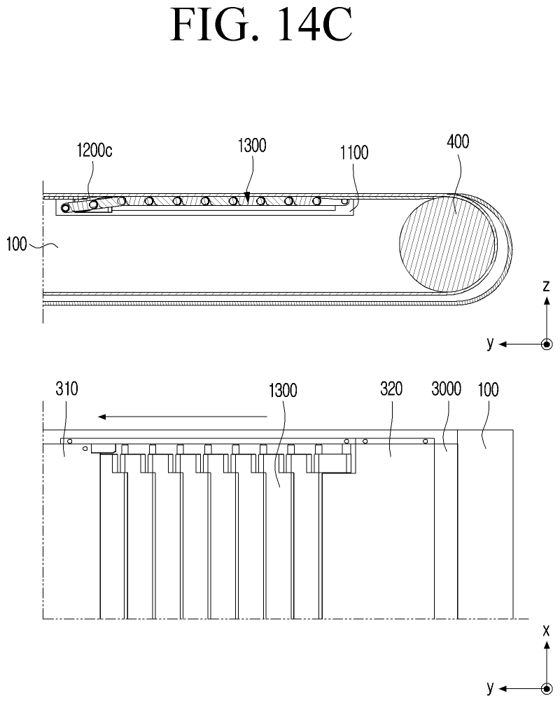

FIGS. 14A, 14B, and 14C are diagrams for illustrating an operation of a deployment device according to various embodiments of the disclosure.

FIG. 14A illustrates a state wherein the guide element 1200 is arranged on the rightmost point 1200a, FIG. 14B illustrates a state wherein the guide element 1200 is arranged on the middle point 1200b, and FIG. 14C illustrates a state wherein the guide element 1200 is arranged on the leftmost point 1200c.

Referring to FIG. 14A, as the guide element 1200 is arranged on the rightmost point 1200a, the plurality of support bars 1310 of the support element 1300 may be arranged on the second rail 1120 of the base element 1100 excluding the rightmost element. Accordingly, the plurality of support bars 1310 of the support element 1300 may be arranged in the lower part of the first support plate 310. Also, as the first support plate 310 is coupled with the guide element 1200, the first support plate 310 may be arranged on the rightmost point. The flexible display 200 coupled to the upper surface of the first support plate 310 may also be arranged on the rightmost point. Accordingly, the flexible display 200 of the electronic device 1 may get in a state of being rolled up maximally.

Referring to FIG. 14B, as the guide element 1200 is arranged on the middle point 1200b, half of the plurality of support bars 1310 of the support element 1300 may be arranged on the first rail 1110 of the base element 1100, and the rest of the plurality of support bars 1310 of the support element 1300 may be arranged between the second rail 1120. Accordingly, half of the plurality of support bars 1310 of the support element 1300 may support the flexible display 200, and the rest of the plurality of support bars 1310 of the support element 1300 may be arranged in the lower part of the first support plate 310. Accordingly, the flexible display 200 of the electronic device 1 may get in a half-unfolded state.

Referring to FIG. 14C, as the guide element 1200 is arranged on the leftmost point 1200c, all of the plurality of support bars 1310 of the support element 1300 may be arranged on the first rail 1110 excluding the leftmost element. Accordingly, all of the plurality of support bars 1310 of the support element 1300 excluding the leftmost element may support the flexible display 200. Accordingly, the flexible display 200 of the electronic device 1 may get in an entirely-unfolded state.

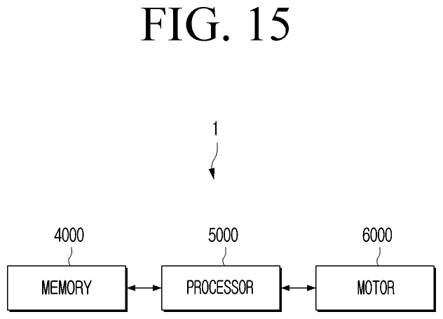

FIG. 15 is a block diagram of an electronic device according to an embodiment of the disclosure.

Referring to FIG. 15, the electronic device 1 may include memory 4000, a processor 5000, and a motor 6000.

The motor 6000 is a component necessary for controlling the driving of the deployment device 1000 of the electronic device 1. Specifically, the motor 6000 may control the driving of the guide element 1200 arranged inside the deployment device 1000, and may thereby drive the support element 1300 to be switched to the first rail 1110 or the second rail 1120. Accordingly, the motor 6000 may perform driving of unfolding or rolling up the flexible display 200.

The memory 4000 is a component for including various types of programs, instructions, and data, and the like, necessary for the operations of the electronic device 1. In FIG. 15, the memory 4000 was illustrated as a separate component from the processor 5000, but the disclosure is not necessarily limited thereto, and the memory 4000 may be implemented as internal memory such as read-only memory (ROM) (e.g., electrically erasable programmable read-only memory (EEPROM)), random access memory (RAM), and the like, included in the processor 5000.

Alternatively, the memory 4000 may be implemented in the form of memory embedded in the electronic device 1, or implemented in the form of memory that can be attached to or detached from the electronic device 1 according to the use of stored data. Specifically, the memory 4000 may be implemented as various forms such as volatile memory (e.g.: static RAM (SRAM), or synchronous dynamic RAM (SDRAM), and the like), non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory, a hard drive, or a solid state drive (SSD)), compact flash (CF), secure digital (SD), micro secure digital (Micro-SD), mini secure digital (Mini-SD), extreme digital (xD), a multi-media card (MMC), and the like.

Also, in the disclosure, the term memory 4000 may be used as a meaning including a storage part, ROM (not shown) and RAM (not shown) inside the processor 5000, or a memory card (not shown) (e.g., a micro SD card, a memory stick) installed on the electronic device. Also, in FIG. 15, it was illustrated that the memory 4000 is one device, but the memory 4000 may be implemented in various numbers.

The memory 4000 is accessed by the processor 5000. In the memory 4000, reading/recording/correction/deletion/update, and the like, of data by the processor 5000 may be performed.

Specifically, the memory 4000 may store various types of information such as location information of the guide element 1200 on the rail, roll-up state information of the flexible display 200, operation information of the guide element 1200 in a video mode, operation information of the guide element 1200 in a multitasking mode, operation information of the guide element 1200 in a web browsing mode, operation information of the roller, and the like, and programs, instructions, for controlling the operations of the electronic device 1 and other devices.

The processor 5000 is a component for being connected with each component of the electronic device 1 and controlling the overall operations of the electronic device 1. The processor 5000 may be implemented as a digital signal processor (DSP) processing digital image signals, a microprocessor, a graphics processing unit (GPU), and the like. However, the disclosure is not limited thereto, and the processor 5000 may include one or more of a central processing unit (CPU), a micro controller unit (MCU), a micro processing unit (MPU), a controller, an application processor (AP) or a communication processor (CP), and an ARM processor, or may be defined by the terms. Also, the processor 5000 may be implemented as a system on chip (SoC) having a processing algorithm stored therein or large scale integration (LSI), or implemented in the form of an application specific integrated circuit (ASIC) or a field programmable gate array (FPGA).

The processor 5000 may perform at least one of the aforementioned various operations based on an artificial intelligence model. The processor 5000 for executing an artificial intelligence model may be implemented through a combination of a generic-purpose processor such as a CPU, an AP, a digital signal processor (DSP), and the like, a graphics-dedicated processor such as a GPU and a vision processing unit (VPU), or an artificial intelligence-dedicated processor such as an NPU and software.

In case the processor 5000 is implemented as an artificial intelligence-dedicated processor, it may be designed as a hardware chip such as an ASIC, an FPGA, and the like, specified for processing of a specific artificial intelligence model.

The processor 5000 may store various types of information received at the electronic device 1 and information generated in the electronic device 1, and the like, in the memory 4000.

The processor 5000 may control the motor 6000 such that the guide element 1200 slides on the first rail 1110 and/or the second rail 1120 of the base element 1100. Also, the processor 5000 may store the point wherein the guide element 1200 is located between the base element 1100 in the memory 4000.

An operation of unfolding or rolling up the flexible display may be controlled by the processor 5000. The processor 5000 may unfold or roll up the flexible display according to various events.

As an example, if an event wherein the user turns on the electronic device 1 occurs, the processor 5000 may perform an operation of unfolding the flexible display, and if an event wherein the user turns off the electronic device 1 occurs, the processor 5000 may perform an operation of rolling up the flexible display.

Alternatively, the processor 5000 may control the flexible display in various forms such as a state of unfolding the entire flexible display, a state of unfolding only a part of the flexible display, a state of rolling up the entire flexible display, and the like, according to an operation mode selected by the user.

For example, if the user selects the video mode, the processor 5000 may control the motor 6000 such that the entire flexible display 200 can be unfolded. That is, the processor 5000 may control the motor 6000 such that the entire support element 1300 can be seated on the first rail 1110 by sliding the guide element 1200 to the leftmost side. In this case, in case the screen size of a video content viewed in a video mode is designated, the processor 5000 may control the flexible display 200 to be unfolded only as much as the size and the ratio corresponding to the screen size, instead of unfolding the entire flexible display 200 unconditionally. As an example, in case a video content is an e-book, the size or the aspect ratio, and the like, of the book may be diverse. The processor 5000 may adjust the size of the flexible display 200 based on such information.

As still another example, if the user sets a web browsing mode, the processor 5000 may control the motor 6000 such that the entire flexible display 200 can be rolled up. In case the user views a video content by using the electronic device 1, a relatively big screen is advantageous for viewing, and thus the entire flexible display 200 is unfolded as described above, but in a web browsing mode of viewing various kinds of websites by executing a web browser, it may be advantageous to miniaturize the flexible display 200 so that the user can perform manipulations of the electronic device 1 easily. Accordingly, if such an event occurs, the processor 5000 may control the flexible display 200 to get in a roll-up state wherein the entire flexible display 200 is rolled up.

Specifically, the processor 5000 may control the motor 6000 such that the entire support element 1300 can be seated on the second rail 1120 by sliding the guide element 1200 to the rightmost side. As another example, if the user sets a music appreciation mode, the processor 5000 may control the motor 6000 such that only a part of the flexible display 200 can be unfolded. That is, an entire screen is not necessary in a music appreciation mode, and thus the processor 5000 may output a music content by using an audio decoder, a speaker, and the like, in a state of unfolding the flexible display 200 in a size wherein information such as the title or the singer name of a music content that is currently being reproduced, the degree of reproduction, the time, and the like, may be displayed, or in a state of not unfolding the flexible display 200 at all.

For performing such operations, the location of the guide element 1200 for each operation mode may be set in advance, and stored in the memory 4000.

If one of the various modes such as the video mode, the web browsing mode, and the music appreciation mode, and the like, is selected, the processor 5000 may adjust the rolling degree of the flexible display 200 by moving the guide element 1200 to a location corresponding to the selected operation mode based on the information stored in the memory 4000.

Other that the above, in case the user inputs a setting instruction for selecting a display size or an aspect ratio, and the like, that the user prefers, the processor 5000 may store the location of the guide element 1200 in that case in the memory 4000, and if the same user is identified afterwards, the processor 5000 may immediately adjust the location of the guide element 1200 to the location. Accordingly, screens in various sizes can be adaptively provided for a user.

Meanwhile, in the above, components and operations were explained based on the electronic device 1 including one housing, but the housing is not necessarily limited to one, and the electronic device 1 may be implemented as a form wherein a plurality of housings are coupled with one another.

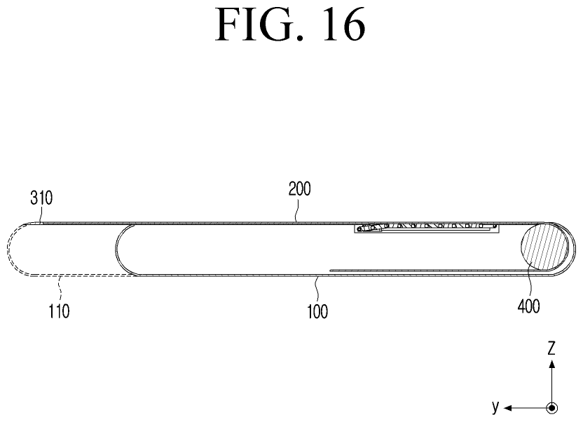

FIG. 16 is a diagram for illustrating the electronic device 1 further including a second housing 110 that is extended according to an embodiment of the disclosure.

Referring to FIG. 16, a second housing 110 may be further included on the outer side of both side surfaces of the housing 100. The second housing 110 may be coupled with the deployment device 1000. Specifically, the second housing 110 may be coupled with the guide element 1200 and the first support plate 310. Accordingly, as the guide element 1200 slides, the second housing 110 may integrally slide together with the guide element 1200, the first support plate 310, and the flexible display 200. Accordingly, the flexible display 200 arranged on the upper surface of the first support plate 310 may be supported by the second housing 110 in the lower part, and thus stability may be increased.

Each of the components described in the disclosure may consist of one or more components, and the titles of the components may vary according to the type of an electronic device.

According to the aforementioned various embodiments, when a flexible display is unfolded or wound, damage to the flexible display as an excessive force is applied to the flexible display may be prevented.

In the above, each of the various embodiments of the disclosure was explained independently, but each embodiment does not necessarily have to be implemented solely, but the components and the operations of each embodiment may be implemented in combination with at least one other embodiment.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a housing of which one surface is open;
a roller;
a flexible display that contacts the roller and is configured to roll;
a first support plate that is coupled with the flexible display within the housing;
a deployment device for adjusting a rolling state of the flexible display by pushing or pulling the first support plate within the housing; and
a second support plate that is coupled with the deployment device on the opposite side of the first support plate based on the deployment device,
wherein the deployment device supports a rear surface of the flexible display while the flexible display is unfolded.

2. The electronic device of claim 1, wherein the deployment device comprises:
a base element that is coupled with the housing, and includes a plurality of rails of different heights;
a guide element that is coupled with the first support plate, and is movable along a longitudinal direction of the plurality of rails; and
a support element that moves to one of the plurality of rails according to a location of the guide element.

3. The electronic device of claim 2,
wherein the plurality of rails comprise:
a first rail that is formed in a location close to the flexible display on an inner side surface of the base element, and
a second rail that is formed in a location farther than the first rail based on the location of the flexible display,
wherein, based on the guide element moving in a first direction, the flexible display is unfolded by the first support plate, and the support element moves to the first rail and supports the rear surface of the flexible display, and
wherein, based on the guide element moving in a second direction opposite to the first direction, the flexible display is rolled up by the first support plate, and the support element moves to the second rail and is spaced from the rear surface of the flexible display.

4. The electronic device of claim 3,
wherein the support element comprises:
a plurality of support bars, and
connecting elements connecting between the plurality of support bars, and
wherein each of the plurality of support bars independently moves to the first rail or the second rail according to the location of the guide element.

5. The electronic device of claim 4,
wherein the guide element comprises:
a guide body that slides along the base element, and
wherein a sliding part that is tapered to connect the first rail and the second rail within the guide body.

6. The electronic device of claim 5, wherein the guide element further comprises:
a screw element for coupling the guide body and the first support plate.

7. The electronic device of claim 4, wherein the connecting elements further comprise:
a first axis element and a second axis element for being assembled to inner side surfaces of the guide element and the base element; and
an elastic body that is arranged between the first axis element and the second axis element, and is for passing through a sliding part of the guide element.

8. The electronic device of claim 4,
wherein the connecting elements further comprise:
a first axis element and a second axis element for being assembled to inner side surfaces of the guide element and the base element, and
a support body that is arranged between the first axis element and the second axis element, and
wherein the first axis element and the second axis element further comprise:
an elastic body that is for passing through a sliding part of the guide element.

9. The electronic device of claim 2, wherein the base element further comprises:
a fixing pin element for fixing both side parts of the support element.

10. The electronic device of claim 5, wherein the guide element further comprises:
a motor for sliding along the first rail and the second rail of the base element.

11. The electronic device of claim 10, further comprising:
memory storing instructions, and
at least one processor coupled to the motor and the memory
wherein the instructions, when executed by the at least one processor individually or collectively, cause the electronic device to:
control the motor such that the guide element slides on the first rail and the second rail of the base element, and
store a point wherein the guide element is located between the base element in the memory.

12. The electronic device of claim 2, wherein the base element further comprises:
a through hole for being coupled with the housing.

13. The electronic device of claim 7, wherein the first axis element and the second axis element further comprise:
a first chamfer that configured to be assembled with the first rail or the second rail;
a second chamfer that has a bigger diameter than the first chamfer, and is arranged on an inner side of the first chamfer, and is for being supported by the inner side surface of the base element; and
a third chamfer that has a bigger diameter than the second chamfer, and is arranged on the inner side of the second chamfer, and is for being fixed to the plurality of support bars.

14. The electronic device of claim 1, wherein the roller further comprises:
a hole for being fixed to the housing.

15. The electronic device of claim 5, wherein the sliding part further comprises:
a switching rail that is tapered such that the plurality of support bars are switched between the first rail and the second rail; and
a first support part and a second support part for preventing detachment of the switching rail.

16. The electronic device of claim 11, wherein the instructions, when executed by the at least one processor individually or collectively, further cause the electronic device to the unfold or roll up the flexible display according to an event.

17. The electronic device of claim 16, wherein the instructions, when executed by the at least one processor individually or collectively, further cause the electronic device to:
perform an operation of unfolding the flexible display, and
wherein, when a user turns off the electronic device, perform an operation of rolling up the flexible display.

18. The electronic device of claim 16, wherein the instructions, when executed by the at least one processor individually or collectively, further cause the electronic device to, when a user selects a video mode, control the motor such that an entirety of the flexible display is unfolded.
